(19) United States
(12) Patent Application Publication
(10) Pub. No.: US 2017/0188242 A1
(43) Pub. Date: Jun. 29, 2017

(54) Method and apparatus for IoT device clustering

(71) Applicant: Intel IP Corporation, Santa Clara, CA (US)

(72) Inventors: Chittabrata Ghosh, Fremont, CA (US); Jeonghun Park, Austin, TX (US)

(73) Assignee: Intel IP Corporation, Santa Clara, CA (US)

(21) Appl. No.: 14/757,628

(22) Filed: Dec. 23, 2015

(51) Int. Cl. H04W 16/18; H04W 24/08

(52) U.S. Cl. CPC H04W 16/18; H04W 24/08

(57) ABSTRACT

The disclosure generally relates to a method, apparatus and system to provide clustering devices associated with a group of so-called Internet of Things (IoT) devices so as to accurately associate multiple devices with a device user. In one embodiment of the disclosure IoT devices transmit cluster identifier requests which are received at one or more Access Points (APs). An AP determines whether to group different IoTs in the same cluster as a function of the received signal power from each IoT. If IoTs are determined to be clustered together, the AP sends a cluster identifier with a time stamp to each IoT in the group. The process is repeated so as to continually identify the IoTs that are proximate enough to be clustered together.

### BACKGROUND

Field

The disclosure relates to a method, apparatus and system to cluster groups of the so-called Internet-of-Things (IoT) devices. Specifically, the disclosure relates to a method, apparatus and system to provide clustering of IoT devices so as to accurately associate multiple devices with a device user.

Description of Related Art

IoT is the interconnection of uniquely identifiable radio-enabled computing devices within the existing Internet infrastructure. IoT offers advanced connectivity of devices, systems and services that extends beyond machine-to-machine (M2M) communications and covers a variety of protocols, domains and applications. The interconnection of these embedded devices is expected to exponentially expedite automation in nearly all fields while also advancing applications like the so-called Smart Grid. Things, in the IoT, include a variety of devices such as heart monitoring devices, biochip transponders, automobiles sensors or field operation devices. By way of example such sensors may be arranged to assist fire-fighters in search and rescue. Current market examples also include smart thermostat systems, heart rate monitor and wrist watches that monitor movement and sleep patterns. The industry is seeing the proliferation of wearable IoT devices in order to enable new classes of user experiences that include seamless and continuous interaction.

Many of the IoT devices are carried on the users or are embedded in devices where they are always on and connected to the cloud. The cloud continually aggregates data from these devices, processes the data and fuse related data from different devices to arrive at suitable conclusions. At the same time many of these wearable devices have a low-battery capacity and the continual cloud communication is detrimental to their battery life.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows an exemplary environment for implementing an embodiment of the disclosure;

FIG. 2 illustrates a conventional IoT clustering technique;

FIG. 3 shows a flow diagram according to one embodiment of the disclosure;

FIG. 4 schematically illustrates the cluster identification step according to one embodiment of the disclosure;

FIG. 5 shows an exemplary process according to another embodiment of the disclosure;

FIG. 6 shows an exemplary embodiment for collecting cluster identifiers;

FIG. 7 schematically illustrates deletion of expired cluster identifier according to one embodiment of the disclosure; and

FIG. 8 is an exemplary apparatus according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications —Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

A class of IoT devices includes a vast array of devices including: smartwatches, a smart glasses and biosensors that can connect to a wireless network. Many such devices connect to the network through a access point (AP). The IoT devices have limited battery life as compared to conventional WiFi devices. The IoT devices are conventionally grouped by the device owner. A person may own a smartwatch, a smartglass and a biosensor simultaneously. IoTs are different from the conventional WiFi devices because each person may have multiple IoT devices.

It is desirable to make a cluster consisting of multiple IoT devices and some conventional WiFi devices as a function of their owner. Forming clusters may realize a benefit from actively exploiting a proximity-based communication between IoT devices (e.g., device-to-device (D2D) communication) and from reducing the device association process. These reduction can reduce energy consumption of the IoT devices.

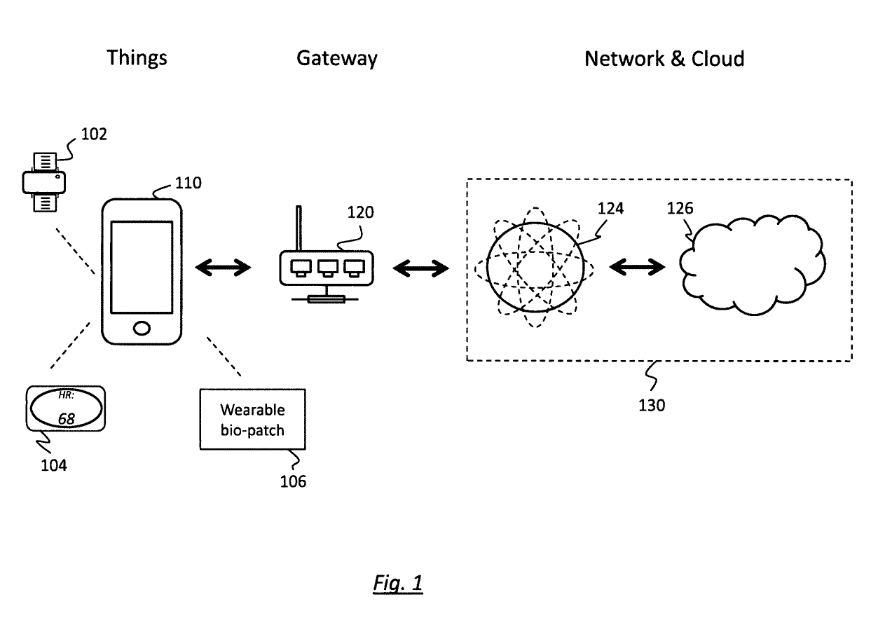

FIG. 1 shows an exemplary environment for implementing an embodiment of the disclosure. In the environment of FIG. 1, devices (wearable IoTs) 102, 104, 106 communicate with smartphone 110. Device 102 is a smartwatch, device 104 is a wearable heart-rate monitor and device 106 is a wearable bio-patch. Devices 102, 104 and 106 are exemplary and may include other common IoTs. Devices 102, 104 and 106 communicate with smartphone 110 with short, bursty and continual signals. While a smartphone is used to illustrate the concept of a HUB for IoT devices, the disclosure is not limited thereto and any communication device with similar communication capacity may be used instead of a smartphone.

Smartphone 110 communicates with Gateway 120. Gateway 120 may comprise a router, a modem, a base station or any other device configured for wireless communication. Gateway 120 communicates with network and cloud infrastructure 130. Network infrastructure 124 includes hardware and software resources that enable network connectivity, communication, operations and management of the entire network. Network infrastructure 124 also provides communication paths between users, processes and external networks. Cloud 126 represents data center infrastructure having different servers and databases.

In a conventional application, data from heart rate monitor 104 is communicated to designated servers (not shown) in cloud 126 for processing. Additional information from smartwatch 102, wearable bio-patch 106 and smartphone 110 may also be routed to cloud 126. The gathered information may then be combined (interchangeably, fused) and analyzed to reach certain conclusions or make educated observations. For example, the data from heart rate monitor 104 can show an increased heart rate. Data from wearable body patch may show increase in the user's pulse rate while data from the smartphone may show rapid acceleration. The data can be fused together at cloud 126 to reach a conclusion that the user may be at a fast moving vehicle. The conclusion can then be forwarded to the user or other entities if desired. The conventional methods are deficient in that the fusion and analysis step may take place on a cloud server. In addition, significant uplink power is consumed to communicate different sensor data from smartphone 110 to gateway 120. Finally, data communication between devices 102, 104 and 106 may interfere with the smartphone's other communication priorities (e.g., LTE, Wi-Fi and Cellular).

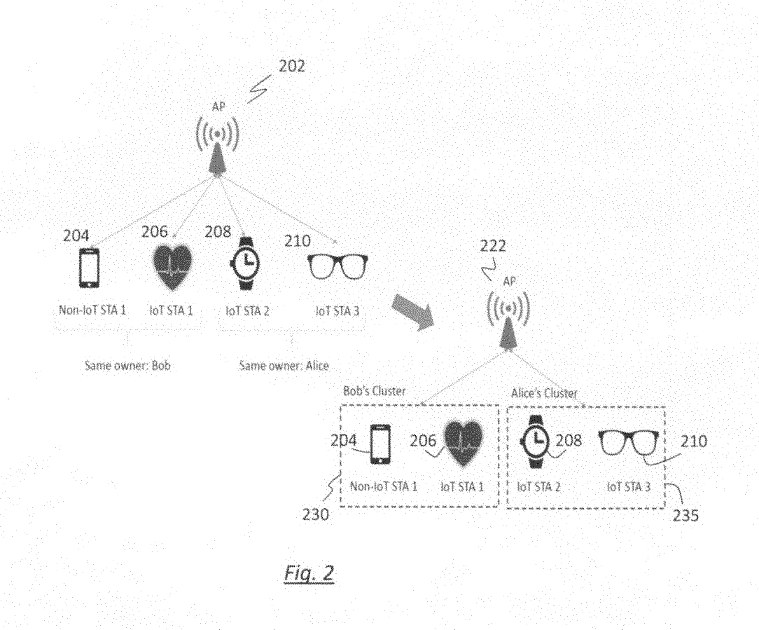

FIG. 2 illustrates a conventional IoT clustering technique. In FIG. 2, AP 202 recognizes IoT devices 204 (smartphone), 206 (biosensor), 208 (smartwatch) and 210 (smart glasses). Each IoT device may define a mobile station (STA). Devices 204 and 206 are owned by user Bob and devices 208 and 210 are owned by user Alice. AP 202 may recognize smartphone 202 as non-IoT STA and biosensor 206 as IoT STA 1, while recognizing smart watch 208 as IoT STA2 and smart glasses 210 as IoT STA 3.

Clustering devices 204, 206, 208 and 210 is not trivial. A problem is that each device cannot recognize the other devices' owner(s) unless each owner manually reports ownership of each device. The manual reporting problem is both tedious and error prone. A conventional solution has been to make a cluster based on proximity among the devices connected to the same AP. This is shown in the lower half of FIG. 2 where AP 222 uses the measured received power (e.g., RSSI) from each device to place devices into clusters. That is, if the received power difference is within a predefined threshold, Pₜₕ, the IoT devices are clustered together. By way of example, devices i and i′ are clustered together if the received power of device i (denoted as Pᵢ) and the received power of device i′ satisfy Equation (1):

|Pᵢ−P_{i′}|<Pₜₕ (1)

This method has a fundamental limitation. In the example shown in FIG. 2, if Bob and Alice have a talk for a while at the same location, the conventional method clusters some of Alice's 235 devices (208, 210) with Bob's 230 devices (204, 206) as shown on the lower portion of FIG. 2.

In one embodiment of the disclosure, the clustering problem of IoT devices may be addressed by assigning multiple cluster identifiers with time stamps to refine the devices included in the same cluster. The cluster identifier may be a group identifier, Base Station (BSS) identifier or a random number generated at any time. The time stamp may be based on real time, or a central clock, or the time synchronization function (TSF) maintained at the access point (AP). The AP may periodically broadcast randomly generated cluster identifiers and current time stamps to all STAs whose received power difference is within a predefined threshold (Pₜₕ). Each STA may store the received cluster identifier and associated time stamp. To avoid memory overflow, old cluster identifiers which are expired may be deleted. This is possible since each cluster identifier is associated with a corresponding time stamp. If the STA collects m number of cluster identifiers, it may send the collected cluster identifiers with the time stamps to the AP. The AP may then generate a cluster by comparing the received cluster identifiers and the time stamps. If two STAs have an identical set of cluster identifiers and time stamps, then they may be included in the same cluster if IoTs. The disclosed embodiments use multiple cluster identifiers to refine clustering when devices are temporarily near each other. For example, if Bob and Alice are at the same location, their collected cluster identifiers and the corresponding time stamps may be identical. However, when they part ways, their IoT cluster identifiers and time stamps may be different.

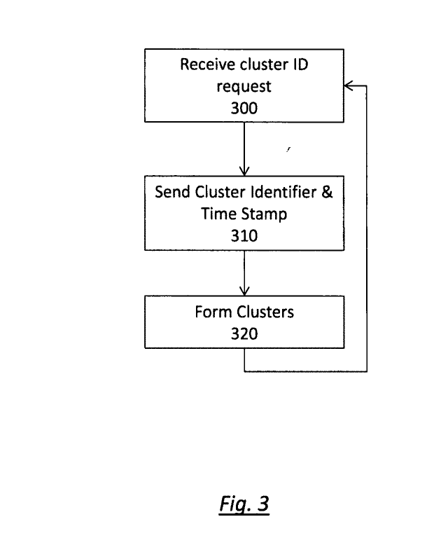

FIG. 3 shows a flow diagram according to one embodiment of the disclosure. The process of FIG. 3 starts when an IoT device or an STA decides to become a cluster member. The IoT device may turn on a feature to be included in a cluster. The feature may be part of an application (Applet) stored on the IoT device. The user may engage the cluster feature by starting the Applet and turning on the cluster feature. In turn, the IoT may send a signal to APs within signal range to request a cluster identifier as shown in step 300.

An AP receiving the cluster identifier request may respond by generating and sending a cluster identifier to the requesting IoT device as shown in step 310. In one embodiment of the disclosure, the cluster identifier may be randomly generated. The cluster may be a new cluster or a previously formed cluster. In another embodiment, the cluster identifier may be part of a predetermined set of numbers. In still another embodiment of the disclosure, the AP may additionally send a time stamp associated with, or corresponding to, the cluster identifier. The IoT may store the cluster identifier and the corresponding time stamp at a local memory. The AP may also store the pertinent information (e.g., IoT identifier information such as UUID, cluster identifier and corresponding time stamp) at a local memory. In this manner, the AP may cluster different IoT devices into the same cluster as shown in step 320. In an exemplary embodiment, the AP may communicate this information to other APs within signal range.

When several IoT devices request cluster identifiers, the AP may determine whether the IoT devices belong to the same cluster. In certain embodiments, the determination can be made as a function of the IoT power as compared with the power from other IoT devices during a time window. The IoT power may be estimated as a function of the signal strength indicator (SSI) received at the AP. When a new IoT device requests cluster identifier, the AP may determine whether the new IoT power is sufficiently close to those of other known IoT devices to warrant clustering. The determination may be made during predetermined time windows. Thus, each IoT may respond to the cluster identifier with a response signal and the AP may then cluster devices whose received power difference is within a predefined power threshold as described in Equation (1).

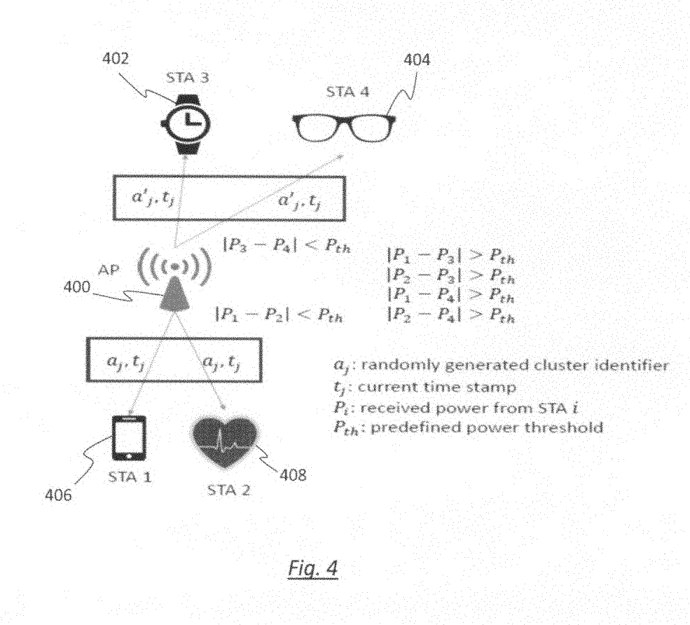

FIG. 4 schematically illustrates an exemplary cluster identification according to one embodiment of the disclosure. In FIG. 4, AP 400 communicates with devices 402, 404, 406 and 408. Each IoT device may request cluster identifier from AP 400. AP 400 may send the randomly generated cluster identifier (denoted as aⱼ) and current time stamp (denoted as tⱼ) to STAs whose received power difference is within a predefined power threshold (denoted as Pₜₕ). Each IoT device (402, 404, 406 and 408) may communicate with AP 400 through a conventional signaling protocol.

A controller (not shown) associated with AP 400 may cluster IoT devices 402, 404, 406 and 408 in different groups. The controller may comprise a processing circuitry in communication with a memory circuitry. The processing and the memory circuitries may define hardware, software or a combination of hardware and software. In one embodiment, the controller (not shown) determines the received power from each IoT and calculates the power differences as shown in FIG. 4 (i.e., |P₁−P₃|; |P₂−P₃|; |P₁−P₄|; |P₂−P₄|; |P₃−P₄|; |P₁−P₂| . . . ) In one exemplary embodiment, the power values are determined during a predefined time window as indicated by a timestamp. Each power difference may then be compared with a predefined power threshold (Pₜₕ). If the power difference for a group of devices is substantially equal or less than the power threshold, then the devices may be clustered together. In FIG. 4, this is shown for devices P₃ and P₄ (clustered together) and for devices P₁ and P₂ (clustered together).

FIG. 4 schematically illustrates two cluster identifiers: aⱼ and aⱼ′. This may be because the signal strength powers (e.g., RSSI) for STA 1 (406) and STA 2 (408) may be substantially similar while STA 3 (402) and STA 4 (404) may have substantially similar signal strength power. Meanwhile, STA 1/STA 2 and STA 3/STA 4 may have different powers.

In one embodiment of the disclosure, when cluster identifier is received, each STA stores it with the corresponding time stamp. The same cluster identifier is sent only if the received power difference between STA 1 and STA 2 is within Pₜₕ. If STA 2 has a different received power whose difference is larger than Pₜₕ, then a different cluster identifier may be sent.

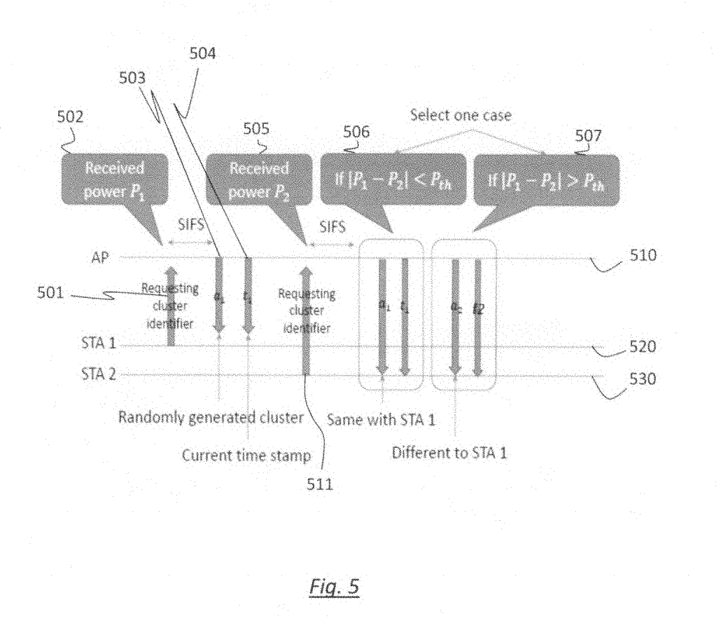

FIG. 5 illustrates an exemplary process for performing steps 300 and 310 of FIG. 3. In FIG. 5, swim lanes represent timelines for each of AP 510, STA 1 (520) and STA 2 (530). At time 502, AP 510 receives one or more signals from STA 1 (520) requesting a cluster identifier 501. AP 510 determines the signal power (P₁) for the signal received from STA1 (520) along with the cluster identification request. At time 503, AP 510 sends randomly generated cluster identifier a₁ to STA1 (520) in response to the cluster identifier request 501. At time 504 (which may be significantly simultaneously with time 503), AP 510 sends a time stamp to STA1 (520). STA1 (520) may store the randomly generated cluster identifier (a₁) and its corresponding time stamp (t₁). In FIG. 5, SIFS denotes the Short Inter-Frame Sensing which is the time required to receive a packet, process the information contained in the packet and transmit a response from the receiver.

At time 505, AP 510 receives a second request 511 for cluster identifier from STA 2 (530). AP 510 may measure the second received signal power (P₂) from STA2 (530). In one embodiment of the disclosure, AP 510 may determine the difference between P₁ and P₂ (i.e., |P₁−P₂|). If the difference is less than the predefined threshold power (Pₜₕ), AP 510 may lump STA1 (520) and STA2 (530) into one cluster as shown in step 506 and communicate the cluster identifier (a₁) and its corresponding time stamp (t₁) to STA2 (530). Under this condition, both STAs have the same cluster identifier (a₁) and the same time identifier (t₁). Each STA may store this information in a local memory.

If the power difference is greater than the threshold power (Pₜₕ), then AP 510 may allocate STA2 to a different cluster and communicate the different cluster identifier (e.g., randomly generated a₂) to STA2 (530) as shown in step 507. In addition, AP 510 may also send a corresponding time stamp, t₂, to STA2 (530) as shown in FIG. 5. In either condition 506 or 507, AP 510 may store the cluster identifier and its corresponding time stamp for each STA at a local memory. The exemplary process of FIG. 5 may continue periodically to continually update cluster identification of the STAs. It should be noted that additional STAs may be included in the exemplary process of FIG. 5 without departing from the disclosed principles.

In one embodiment of the disclosure, communications between AP 510 and SATs 520 and 530 uses conventional channel sensing. Thus, only one STA may communicate with AP 530 at a time.

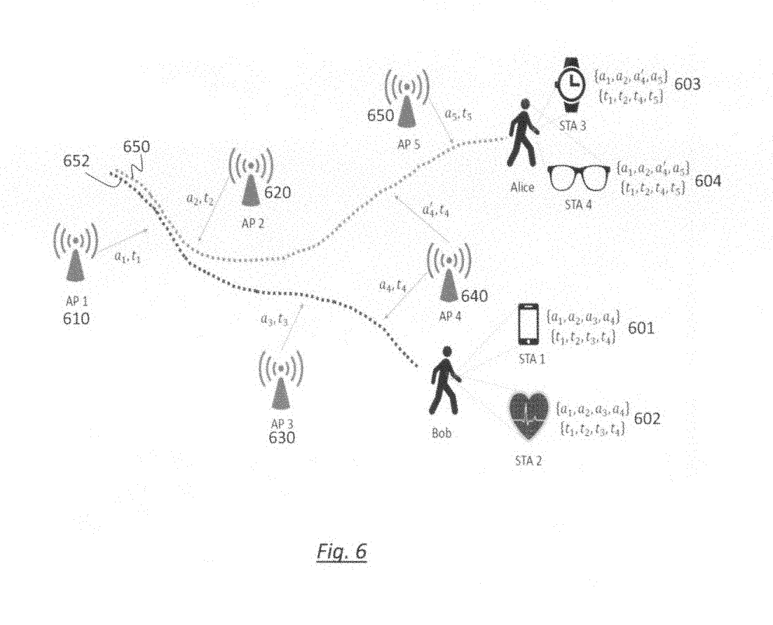

FIG. 6 shows an exemplary embodiment for collecting cluster identifiers. Specifically, FIG. 6 schematically illustrates assigning cluster identifiers assuming there are four STAs (i.e., STA1 (601), STA2 (602), STA3 (603) and STA4 (604)) with two personal owners (Alice and Bob). Each personal owner has two devices as shown. Further, FIG. 6 has paths 650 and 652 which denote movement of IoT device owners, Alice and Bob. The process of FIG. 6 may be viewed in multiple times. Here, it is assumed that each STA collects four cluster identifiers (from each of AP1 (610), AP2 (620), AP3 (630) and AP4 (640)) and corresponding time stamps received from each AP. Thus, each of Bob's devices and Alice's devices has the same first two cluster identifiers a₁, a₂. This is because Bob and Alice were initially proximal (near AP1 (610) and AP2 (620)).

However, Bob and Alice's cluster identifiers become different when they move to different locations traversing along paths 650 and 652. In accordance with one embodiment of the disclosure to avoid memory overflow, old cluster identifiers may be allowed to expire and subsequently deleted. As shown in FIG. 6, Alice has cluster identifiers a₁, a₂, a_{4′} and a₄, corresponding to timestamps t₁, t₂, t₄ and t₅, respectively. It should be noted that AP4 (640) issues cluster identifier a₄ to Bob at t₄ while issuing cluster identifier a_{4′} to Alice at time t₄. Similarly, Bob has cluster identifiers a₁, a₂, a₃ and a₄ (note that Alice was not exposed to AP3 (630)) which correspond to timestamps t₁, t₂, t₃ and t₄, respectively.

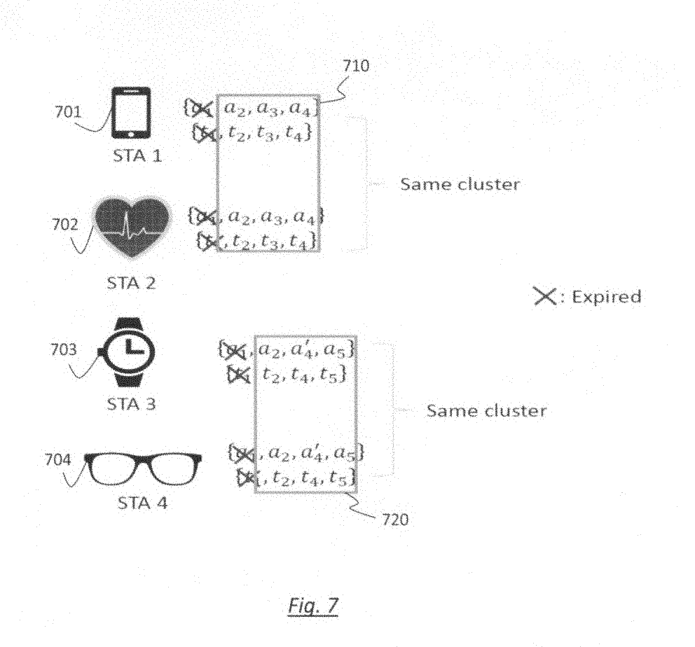

FIG. 7 schematically illustrates deletion of expired cluster identifier according to one embodiment of the disclosure. In FIG. 7 each of devices STA1 (701), STA2 (702), STA3 (703) and STA4 (704) collects cluster identifiers throughout a period of time. The cluster identifiers are shown as a₁, a₂, a₃, a₄, a₄′ and a₅, corresponding to timestamps t₁, t₂, t₃, t₄, t_{4′} and t₅, respectively. The cluster identifiers and corresponding timestamps are recorded for each of the STAs and are saved in a memory. This information may be recorded at one or more APs (not shown) or at the local memory (not shown) of each STA. As time lapses, the older, expired, information may be deleted. This is shown schematically through windows 710 and 720 where cluster a₁ and corresponding timestamp t₁ are expired and deleted. In the exemplary embodiment of FIG. 7, the memory is set to record the last three cluster identifiers and their corresponding timestamps. Thus, each STA collects cluster identifiers until the number of collected identifier reaches m, indicating the maximum numbers of collected cluster identifiers. In FIG. 7, it is assumed that m=3. It can be observed that the cluster identifier a₁ is expired after receipt of cluster identifier a₄.

In one implementation, after collecting m cluster identifiers, each STA may send the collected information to one or more APs or to a server (e.g., a cloud server). The AP may then determine a group of STA clustering based on the received cluster identifier set. For example, in FIG. 7, the cluster are made according to {STA 1, STA 2}, {STA3, STA4} since their cluster identifiers are identical.

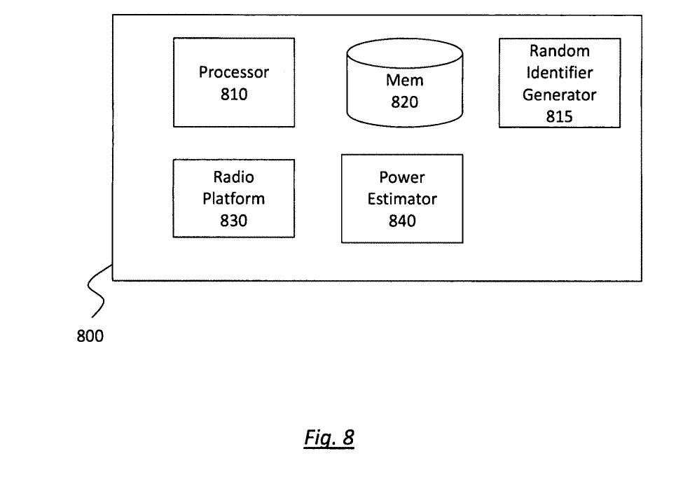

FIG. 8 is an exemplary apparatus according to one embodiment of the disclosure. Apparatus 800 may define an AP. In one embodiment, apparatus 800 may define a module configured to be integrated with an AP. Apparatus 800 may comprise hardware, software or a combination of hardware and software. For example, apparatus 800 may be implemented in software and added to existing an AP. Apparatus 800 is shown with processing circuitry 810, memory 820 and radio communication platform 830. The communication platform may include frontend and backend radio circuitries along with corresponding antennas (not shown). Platform 800 may be configured for different communication modes (e.g., cellular, WiFi, BLE, etc.). Apparatus 800 is also shown with power estimator 840 which may be configured to estimate a received signal's power using known techniques.

Processor 810 may communicate with memory 820, radio platform 830 and power estimator 840. Memory 820 may store non-transitory instructions to direct processor 810 and radio platform 830 to conduct various functions. Memory 820 may also receive and store various information consistent with the disclosed embodiments.

In one embodiment, apparatus 820 may receive a first request (in the form of a signal) for cluster identifier from a first IoT device (not shown). The first request may be received at radio platform 830 and communicated to processor 810 (and optionally memory 820). The received signal's power may be estimated by power estimator 840. The first request may include, among others, information identifying the requesting IoT device (e.g., UUID). Processor 810 may optionally estimate a general or a specific location determination for the first IoT. The location information may optionally be stored at memory 820 and/or communicated to the first IoT.

Responsive to the request for cluster identifier, processor 810 may assign a randomly generated cluster identifier to the first IoT and communication the same to the first IoT. Random cluster identifier generator 815 may be configured to randomly generate cluster identifiers. The randomly generated cluster identifier may be assessed based on the first request's signal power. In one embodiment, the first request's signal power may be compared with signal power of known clusters and if sufficiently close, a known cluster identifier may be communicated to the first IoT. Processor 810 may also communicate a first time stamp to the first IoT. Finally, the cluster information, the time stamp and information identifying the first IoT may be stored at Memory 820.

Radio platform 830 may receive a second request for cluster identifier from a second IoT. The request may be related to processor 810 (and optionally, memory 820). Processor 810 may communicate signal power with power estimator 840. The processor may also determine if the difference between first signal power and second signal power is substantially less than a predetermined threshold. Processor 810 may assign a known or a randomly assigned cluster identifier.

The following examples are provided to further illustrate non-limiting and exemplary embodiments and/or implementations of the disclosure. Example 1 is directed to an Access Point (AP), comprising: a receiver to receive a first and a second request signals for cluster identifiers from a first mobile station (STA) and a second STA, respectively; a processor circuitry to compare a respective signal power associated with each of the first and the second request signals with a threshold power value and to determine whether to cluster the first STA together with the second STA; a transmitter to communicate with the processor, the transmitter configured to transmit a cluster identifier and a time stamp to each of the first STA and the second STA if the processor circuitry determines to cluster the first STA and the second STA together, and to transmit a plurality of cluster identifiers and corresponding time stamps to each of the first STA and the second STA if the processor circuitry determines to cluster the first STA and the second STA independently from one another.

Example 2 is directed to the AP of example 1, further comprising a memory to store the first cluster identifier and a first time stamp associated with the first cluster identifier.

Example 3 is directed to the AP of any preceding example, wherein the processor circuitry is configured with instructions to remove the first cluster identifier and the first time stamp from the memory to store a subsequent cluster identifier and an associated subsequent time stamp.

Example 4 is directed to the AP of any preceding example, wherein the cluster identifier comprises a group identifier, a Base Station identifier or a random number generated at any time and wherein the time stamp is based on real time, a central clock or a time synchronization function (TSF) maintained at the AP.

Example 5 is directed to the AP of any preceding example, further comprising a random generator to generate one or more cluster identifiers responsive to the request signals for cluster identifiers.

Example 6 is directed to the AP of any preceding example, wherein the processor circuitry is further configured to communicate with the receiver and to estimate a first signal power (P1) and a second signal power (P2) for each of the first request signal and the second request signal, respectively.

Example 7 is directed to the AP of any preceding example, wherein the processor circuitry is configured to determine a signal power difference value between the first signal power (P1) and a second signal power (P2) and to compare the signal power difference value with a threshold value (Pth).

Example 8 is directed to the AP of any preceding example, wherein the processing circuitry is configured to cluster the first STA with a second STA if the difference between the first signal power (P1) and the second signal power (P2) is equal or less than a threshold power value (Pth).

Example 9 is directed to the AP of any preceding example, wherein the processing circuitry is configured to cluster the first STA with a second STA independently if the difference between the first signal power (P1) and the second signal power (P2) is greater than the threshold power value (Pth).

Example 10 is directed to a non-transitory computer-readable storage medium that contains instructions, which when executed by one or more processors results in performing operations comprising: determining a first signal power (P1) for a first cluster request signal received from a first mobile station (STA); determining a second signal power (P2) for a second cluster request signal received from a second STA; comparing the difference between the first signal power (P1) and the second signal power (P2) with a threshold power value (Pth) to determine whether to cluster the first and the second mobile STAs together; and clustering the first STA with a second STA if the difference between the first signal power (P1) and the second signal power (P2) is equal or less than a threshold power value (Pth) or clustering the first STA and the second STA independently if the difference between the first signal power (P1) and the second signal power (P2) is greater than the threshold power value (Pth).

Example 11 is directed to the medium of example 11, further comprising transmitting a first cluster identifier and a first time stamp to each of the first STA and the second STA if the processor circuitry determines to cluster the first STA with the second STA and transmitting an independent cluster identifier and a time stamp to each of the first and the second STA if the processor circuitry determines to cluster the first and the second STA independently.

Example 12 is directed to the medium of any preceding example, further comprising storing cluster identifier and corresponding time stamp for each of the first and the second STA.

Example 13 is directed to the medium of any preceding example, further comprising periodically generating one or more random cluster identifiers and a corresponding one or more time stamps.

Example 14 is directed to the medium of any preceding example, wherein determining a first signal power further comprises measuring a Receive Signal Strength Indicator (RSSI) associated with the first signal.

Example 15 is directed to the medium of claim any preceding example, further comprising periodically determining signal power associated with each of the first STA and the second STA and determining whether to transmit one or more new cluster identifiers to each of the first and the second STA.

Example 16 is directed to a method to assign mobile devices to one or more cluster group, the method comprising: determining a first signal power (P1) for a first cluster request signal received from a first mobile Station (STA); determining a second signal power (P2) for a second cluster request signal received from a second STA; comparing the difference between the first signal power (P1) and the second signal power (P2) relative to a threshold power value (Pth); and clustering the first STA with a second STA if the difference between the first signal power (P1) and the second signal power (P2) is equal or less than a threshold power value (Pth) or clustering the first STA and the second STA independently if the difference between the first signal power (P1) and the second signal power (P2) is greater than the threshold power value (Pth).

Example 17 is directed to the method of example 16, further comprising transmitting a first cluster identifier and a first time stamp to each of the first STA and the second STA if the processor circuitry determines to cluster the first STA with the second STA and transmitting a different cluster identifier and a time stamp to each of the first STA and the second STA if the processor circuitry determines to cluster the first and the second STA independently.

Example 18 is directed to the method of any preceding example, further comprising storing a cluster identifier and a corresponding time stamp for each of the first and the second STA.

Example 19 is directed to the method of any preceding example, further comprising periodically generating one or more random cluster identifiers and one or more corresponding time stamps.

Example 20 is directed to the method of any preceding example, wherein determining a first signal power further comprises measuring a Receive Signal Strength Indicator (RSSI) associated with the first signal.

Example 21 is directed to the method of any preceding example, further comprising periodically determining signal power associated with signals generated from each of the first STA and the second STA and determining whether to transmit one or more new cluster identifiers to each of the first STA and the second STA.

Example 22 is directed to an Access Point (AP) to assign mobile devices to one or more cluster group, comprising: means for determining a first signal power (P1) for a first cluster request signal received from a first mobile Station (STA); means for determining a second signal power (P2) for a second cluster request signal received from a second STA; means for comparing the difference between the first signal power (P1) and the second signal power (P2) with a threshold power value (Pth); and means for clustering the first STA with a second STA if the difference between the first signal power (P1) and the second signal power (P2) is equal or less than a threshold power value (Pth) or clustering the first STA and the second STA independently if the difference between the first signal power (P1) and the second signal power (P2) is greater than the threshold power value (Pth).

Example 23 is directed to the AP of any preceding example, further comprising means for transmitting a first cluster identifier and a first time stamp to each of the first STA and the second STA if the processor circuitry determines to cluster the first STA with the second STA and transmitting an independent cluster identifier and a time stamp to each of the first and the second STA if the processor circuitry determines to cluster the first and the second STA independently.

Example 24 is directed to the AP of any preceding example, further comprising means for storing cluster identifier and corresponding time stamp for each of the first and the second STA.

Example 25 is directed to the AP of any preceding example, further comprising means for periodically generating one or more random cluster identifiers and a corresponding one or more time stamps.

Example 26 is directed to the AP of any preceding example, wherein determining a first signal power further comprises measuring a Receive Signal Strength Indicator (RSSI) associated with the first signal.

Example 27 is directed to the AP of any preceding example, further comprising means for periodically determining signal power associated with each of the first STA and the second STA and determining whether to transmit one or more new cluster identifiers to each of the first and the second STA.

Example 28 is directed to machine-readable storage including machine-readable instructions, when executed, to implement a method or realize an apparatus as claimed in any preceding example.

Example 29 is directed to a machine-readable medium including code, when executed, to cause a machine to perform the method of any one of the examples 22-27.

While the principles of the disclosure have been illustrated in relation to the exemplary embodiments shown herein, the principles of the disclosure are not limited thereto and include any modification, variation or permutation thereof.

What is claimed is:

1. An Access Point (AP), comprising:
a receiver to receive a first and a second request signals for cluster identifiers from a first mobile station (STA) and a second STA, respectively;
a processor circuitry to compare a respective signal power associated with each of the first and the second request signals with a threshold power value and to determine whether to cluster the first STA together with the second STA;
a transmitter to communicate with the processor, the transmitter configured to transmit a cluster identifier and a time stamp to each of the first STA and the second STA if the processor circuitry determines to cluster the first STA and the second STA together, and to transmit a plurality of cluster identifiers and corresponding time stamps to each of the first STA and the second STA if the processor circuitry determines to cluster the first STA and the second STA independently from one another.

2. The AP of claim 1, further comprising a memory to store the first cluster identifier and a first time stamp associated with the first cluster identifier.

3. The AP of claim 2, wherein the processor circuitry is configured with instructions to remove the first cluster identifier and the first time stamp from the memory to store a subsequent cluster identifier and an associated subsequent time stamp.

4. The AP of claim 2, wherein the cluster identifier comprises a group identifier, a Base Station identifier or a random number generated at any time and wherein the time stamp is based on real time, a central clock or a time synchronization function (TSF) maintained at the AP.

5. The AP of claim 1, further comprising a random generator to generate one or more cluster identifiers responsive to the request signals for cluster identifiers.

6. The AP of claim 1, wherein the processor circuitry is further configured to communicate with the receiver and to estimate a first signal power (P₁) and a second signal power (P2) for each of the first request signal and the second request signal, respectively.

7. The AP of claim 1, wherein the processor circuitry is configured to determine a signal power difference value between the first signal power (P₁) and a second signal power (P2) and to compare the signal power difference value with a threshold value (Pₜₕ).

8. The AP of claim 7, wherein the processing circuitry is configured to cluster the first STA with a second STA if the difference between the first signal power (P₁) and the second signal power (P₂) is equal or less than a threshold power value (Pₜₕ).

9. The AP of claim 7, wherein the processing circuitry is configured to cluster the first STA with a second STA independently if the difference between the first signal power (P₁) and the second signal power (P₂) is greater than the threshold power value (Pₜₕ).

10. A non-transitory computer-readable storage medium that contains instructions, which when executed by one or more processors results in performing operations comprising:
determining a first signal power (P₁) for a first cluster request signal received from a first mobile station (STA);
determining a second signal power (P₂) for a second cluster request signal received from a second STA;
comparing the difference between the first signal power (P₁) and the second signal power (P₂) with a threshold power value (Pₜₕ) to determine whether to cluster the first and the second mobile STAs together; and
clustering the first STA with a second STA if the difference between the first signal power (P₁) and the second signal power (P₂) is equal or less than a threshold power value (Pₜₕ) or clustering the first STA and the second STA independently if the difference between the first signal power (P₁) and the second signal power (P₂) is greater than the threshold power value (Pₜₕ).

11. The medium of claim 11, further comprising transmitting a first cluster identifier and a first time stamp to each of the first STA and the second STA if the processor circuitry determines to cluster the first STA with the second STA and transmitting an independent cluster identifier and a time stamp to each of the first and the second STA if the processor circuitry determines to cluster the first and the second STA independently.

12. The medium of claim 11, further comprising storing cluster identifier and corresponding time stamp for each of the first and the second STA.

13. The medium of claim 12, further comprising periodically generating one or more random cluster identifiers and a corresponding one or more time stamps.

14. The medium of claim 11, wherein determining a first signal power further comprises measuring a Receive Signal Strength Indicator (RSSI) associated with the first signal.

15. The medium of claim 11, further comprising periodically determining signal power associated with each of the first STA and the second STA and determining whether to transmit one or more new cluster identifiers to each of the first and the second STA.

16. A method to assign mobile devices to one or more cluster group, the method comprising:
determining a first signal power (P₁) for a first cluster request signal received from a first mobile Station (STA);
determining a second signal power (P₂) for a second cluster request signal received from a second STA;
comparing the difference between the first signal power (P₁) and the second signal power (P₂) with a threshold power value (Pₜₕ); and
clustering the first STA with a second STA if the difference between the first signal power (P₁) and the second signal power (P₂) is equal or less than a threshold power value (Pₜₕ) or clustering the first STA and the second STA independently if the difference between the first signal power (P₁) and the second signal power (P₂) is greater than the threshold power value (Pₜₕ).

17. The method of claim 16, further comprising transmitting a first cluster identifier and a first time stamp to each of the first STA and the second STA if the processor circuitry determines to cluster the first STA with the second STA and transmitting an independent cluster identifier and a time stamp to each of the first and the second STA if the processor circuitry determines to cluster the first and the second STA independently.

18. The method of claim 16, further comprising storing cluster identifier and corresponding time stamp for each of the first and the second STA.

19. The method of claim 18, further comprising periodically generating one or more random cluster identifiers and a corresponding one or more time stamps.

20. The method of claim 16, wherein determining a first signal power further comprises measuring a Receive Signal Strength Indicator (RSSI) associated with the first signal.

21. The method of claim 16, further comprising periodically determining signal power associated with each of the first STA and the second STA and determining whether to transmit one or more new cluster identifiers to each of the first and the second STA.
